(19) United States
(12) Patent Application Publication
(10) Pub. No.: US 2015/0112737 A1
(43) Pub. Date: Apr. 23, 2015

(54) ENTERPRISE ACCESS TO SURVEY TOOLS

(71) Applicant: SURVEYMONKEY INC., Palo Alto, CA (US)

(72) Inventors: COLIN MICHAEL SAUNDERS, San Francisco, CA (US); PAUL KUEI-PU HUANG, Cupertino, CA (US); YIN CHUN (OSCAR) CHAN, Milpitas, CA (US); CHRISTOPHER ALAN GEORGE, Sunnyvale, CA (US)

(73) Assignee: SURVEYMONKEY INC., Plo Alto, CA (US)

(21) Appl. No.: 14/061,368

(22) Filed: Oct. 23, 2013

(51) Int. Cl. G06F 21/62; G06Q 10/02; G06Q 10/10; G06Q 10/06

(52) U.S. Cl. CPC G06F 21/6218; G06Q 10/06; G06Q 10/02; G06Q 10/107
USPC 705/5; 707/783

(57) ABSTRACT

A system includes an enterprise repository configured to store at least one list of users associated with an organization and at least one list of surveys associated with the organization, an invitation module configured to allow an inviting user associated with the organization to designate at least one invitee to become associated with the organization and monitor acceptance by the invitee, a management module configured to associate the invitee with the organization in the list of users upon invitation acceptance, the management module to monitor the list of users to ensure a number of users on the list does not exceed a predetermined number of granted licenses, and a data repository, the data repository configured to store data received from the surveys generated by the users associated with the organization, wherein at least one user associated with the data repository has access rights to the data received through surveys.

### BACKGROUND

Survey tools provide organizations and individuals valuable information with regard to their good and services. This information may include customer preferences, feedback on products and/or services, demographic information to allow the organizations or individuals to identify their target populations.

Currently, even for organizations, users set up their accounts as individuals. The accounts allow them to sign up for the services, generate the surveys, view the data and go over the analysis as individuals. No mechanisms exist for organizations to have shared accounts, shared access to the resulting data, save money by combining accounts, or to gather individual accounts into a new organization account.

### BRIEF DESCRIPTION OF THE DRAWINGS

FIG. 1 shows an embodiment of a networked system providing access to survey tools.

FIG. 2 shows an embodiment of an electronic device having the capability to implement aspects of the embodiments.

FIG. 3 shows an embodiment of a survey provider system for establishing and managing enterprise accounts.

FIG. 4 shows a flowchart of an embodiment of a method of providing access to survey tools as an enterprise.

FIG. 5 shows an embodiment of a user interface for inviting users to an enterprise survey account.

FIG. 6 shows embodiments of user interfaces depicting account status of seats taken.

FIG. 7 shows an embodiment of list views for an enterprise account.

FIG. 8 shows an embodiment of a user interface for an invited user.

FIG. 9 shows a flowchart of an embodiment of combining an existing user account to an enterprise account.

FIG. 10 shows a flowchart of an embodiment of a method to manage individual user accounts within an entity account.

FIG. 11 shows an embodiment of user interface allowing a user to combine an individual account into an enterprise account.

FIG. 12 shows an embodiment of a user interface for a user to reassign an individual account to an enterprise account.

### DETAILED DESCRIPTION OF THE EMBODIMENTS

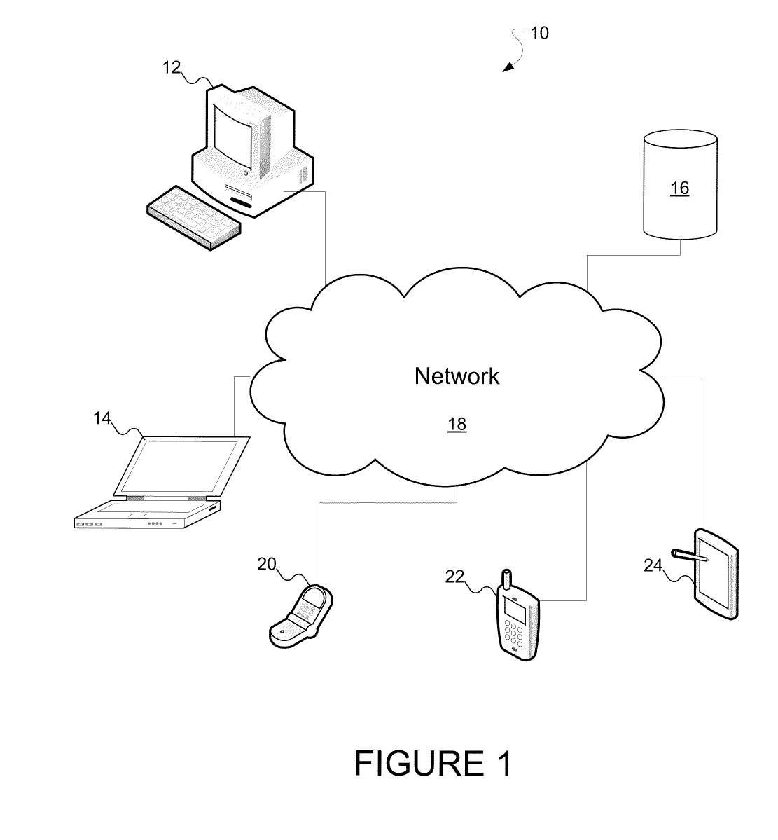

FIG. 1 shows an example of a networked system 10 in accordance with certain embodiments of the disclosed technology. In this example, the system 10 includes a network 18 such as the Internet, an intranet, a home network, a public network, or any other network suitable for implementing the embodiments discussed here. In the example, personal computers 12 and 14 may connect to the network 18 to communicate with each other or with other devices connected to the network.

The system 10 may also include three mobile electronic devices 20, 22 and 24. Two of the mobile electronic devices 20 and 22 may be communications devices such as may be cellular telephones or smartphones. Another of the mobile devices 24 may be a handheld computing device such as a personal digital assistant (PDA), tablet device, or other portable device. A storage device 16 may store some of all of the data that is accessed or otherwise used by any or all of the computers 12 and 14 and mobile electronic devices 20, 22 and 24. The storage device 16 may be local or remote with regard to any or all of the computers 12, 14 and mobile electronic devices 20-24. The storage device may consist of one or more databases, as will be discussed in more detail later, and may actually consist of one or many physical memory devices. One must note that the system of FIG. 1 is merely intended as an example to demonstrate possible devices connected to a network.

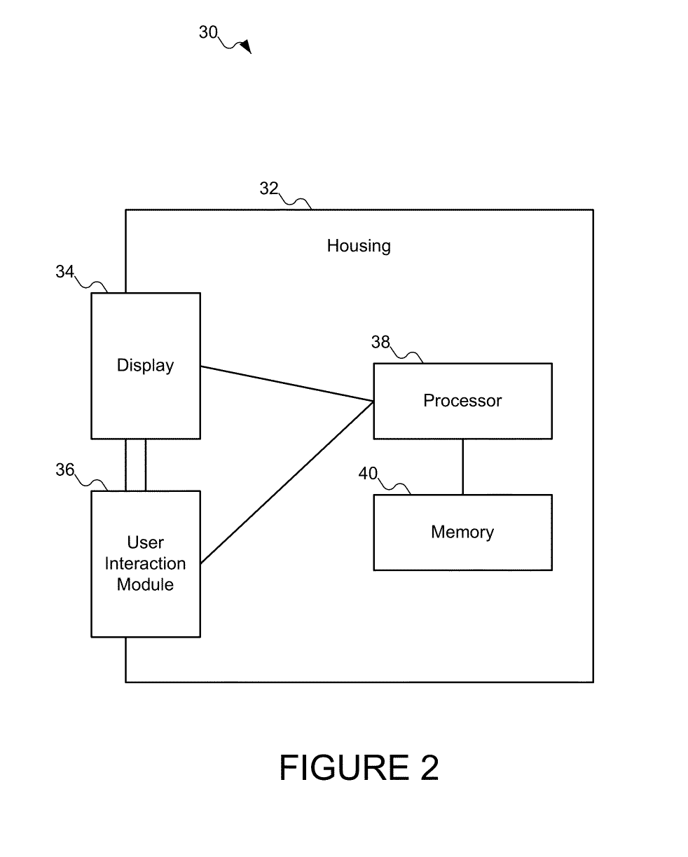

FIG. 2 illustrates an example of an electronic device 30, such as any of the devices of FIG. 1, in which certain aspects of various embodiments of the embodiments may be implemented. The electronic device 30 may include, but is not limited to, a personal computing device such as a desktop or laptop computer, a mobile electronic device such as a PDA or tablet computing device, a mobile communications device such as a smartphone, an industry-specific machine such as a self-service kiosk or automated teller machine (ATM), or any other electronic device suitable for use in connection with certain embodiments of the disclosed technology.

In the example, the electronic device 30 includes a housing 32, a display 34 in association with the housing 32, a user interaction module 36 in association with the housing 32, a processor 38, and a memory 40. The user interaction module 36 may include a physical device, such as a keyboard, mouse, microphone, speaking, or any combination thereof, or a virtual device, such as a virtual keypad implemented within a touchscreen. The processor 38 may perform any of a number of various operations. The memory 40 may store information used by or resulting from processing performed by the processor 38.

A user desiring access to survey tools will typically utilize such a device to contact a survey provider to set up an account to access the tools. The user currently can only get individual access. Any surveys created, data gathered, analysis performed and stored will only be available to the user who signed up. With use of the embodiments here, however, the user can create an enterprise account. An ‘enterprise’ as that term is used here applies to any group of more than one person, whether that group be a corporation, a non-profit, a charity, a sports team, etc. By employing an enterprise account, the user can designate more than just his or herself to have access to the surveys, create surveys, access the data and analysis, perform his or her own analysis, etc.

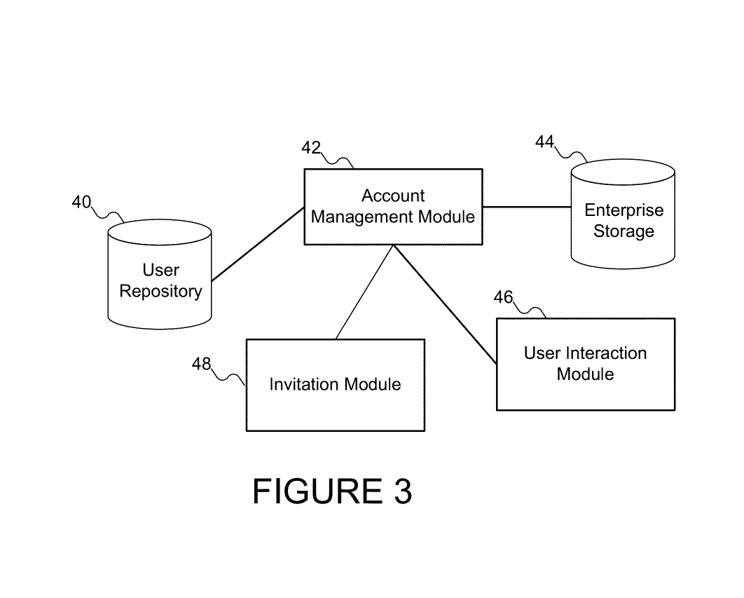

FIG. 3 shows an embodiment of a survey provider system that allows users to establish and manage enterprise accounts. The system includes a user repository 40 and an enterprise repository 44. The user repository 40 may include a database or other means to associate a user with an enterprise account. The enterprise storage 44 may include a database or other means to associate an enterprise with an account and the data associated with the enterprise. This data may include surveys created by the enterprise, data accumulated from the surveys and any analysis data, and any other data. These two repositories as well as any others may consist of one repository or several repositories distributed across the network.

The survey provider system also includes an account management module 42 that allows the survey provider to allow the user to manage the enterprise account by adding and removing users, identifying any invited users as previously existing users, joining and separating accounts, etc. An invitation module 48 manages the invitations process, which will be discussed in more detail later. A user interaction module 46 provides the user interfaces that will be discussed in more detail later, the user interfaces allow the user to interact with the system to provide the necessary information to establish and manage enterprise accounts.

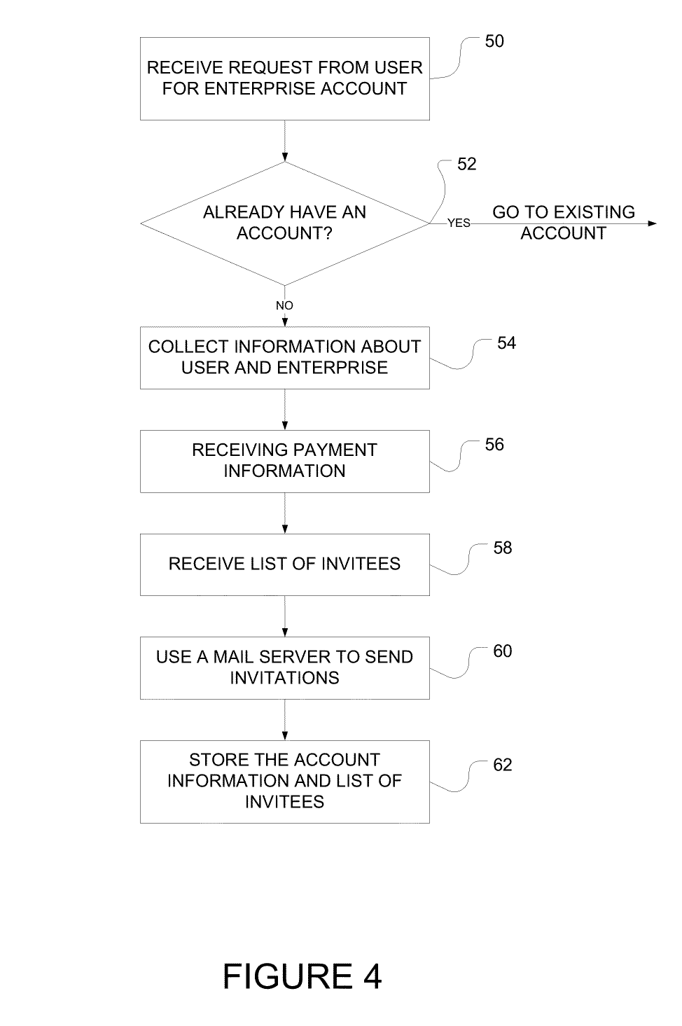

FIG. 4 shows a flow chart of a general approach to the creation and establishment of an enterprise account from the point of view of the survey tool provider. At 50, a request is received from a user for an enterprise account. This request may arise in many different contexts. For example, an existing survey provider account holder may receive an inquiry from the survey provider as to whether that user would be interested in an enterprise account. The user may have contacted the survey provider and expressed an interest in an enterprise account. The survey provider may have sent out emails to existing users about moving to enterprise accounts, etc.

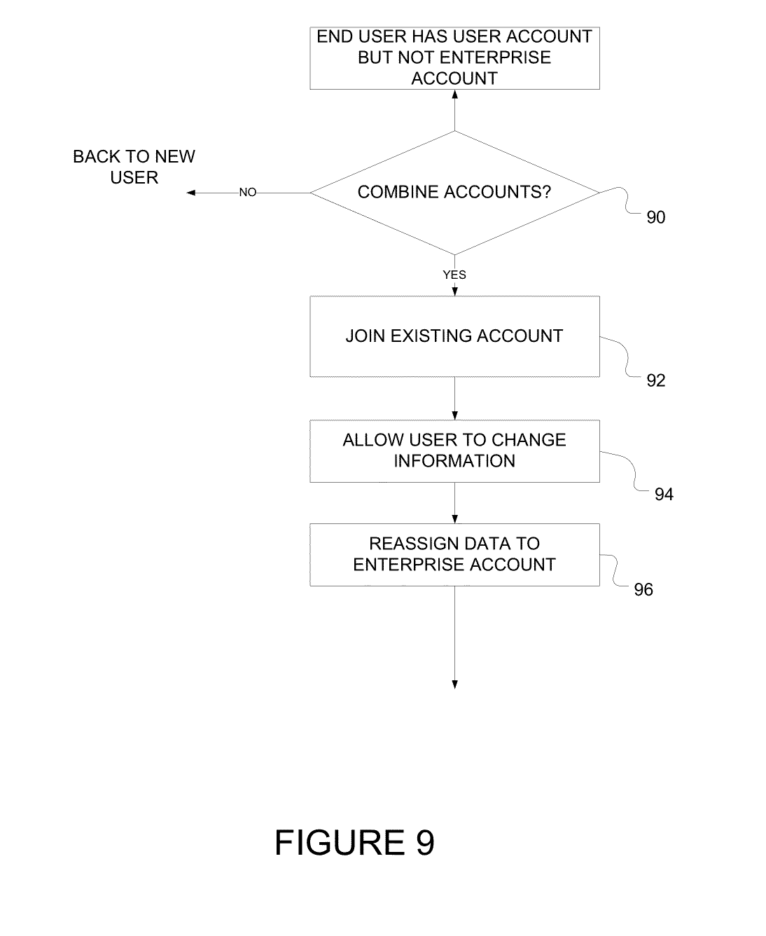

The survey provider may ask the user if the user already has an account at 52. If the user already has an account, the process moves to a discussion about account management with reference to FIG. 9. The remaining portion of the process may be referred to as the new user process. The survey provider collects information about the user and the enterprise at 54. This information will include identification of the entity, the user's status as the enterprise account owner and administrator, the number of seats desired, etc. The survey provider will then gather the payment information at 56. Payment may be made through a credit card, an online payment account, an invoice and purchase order process, or any other manner in which the survey provider can receive and confirm payment.

The survey provider then prompts the user for invitees to fill the number of seats. The user does not have to designate enough invitees to fill the seats immediately. The user provides the list of invitees and the survey provider will receive the list and at 58 and will use a mail server to send invitations to the invitees at 60. This information is then stored to allow the survey provider to monitor and assist the user in managing the account. The storage may consist of one or more repositories, as discussed above.

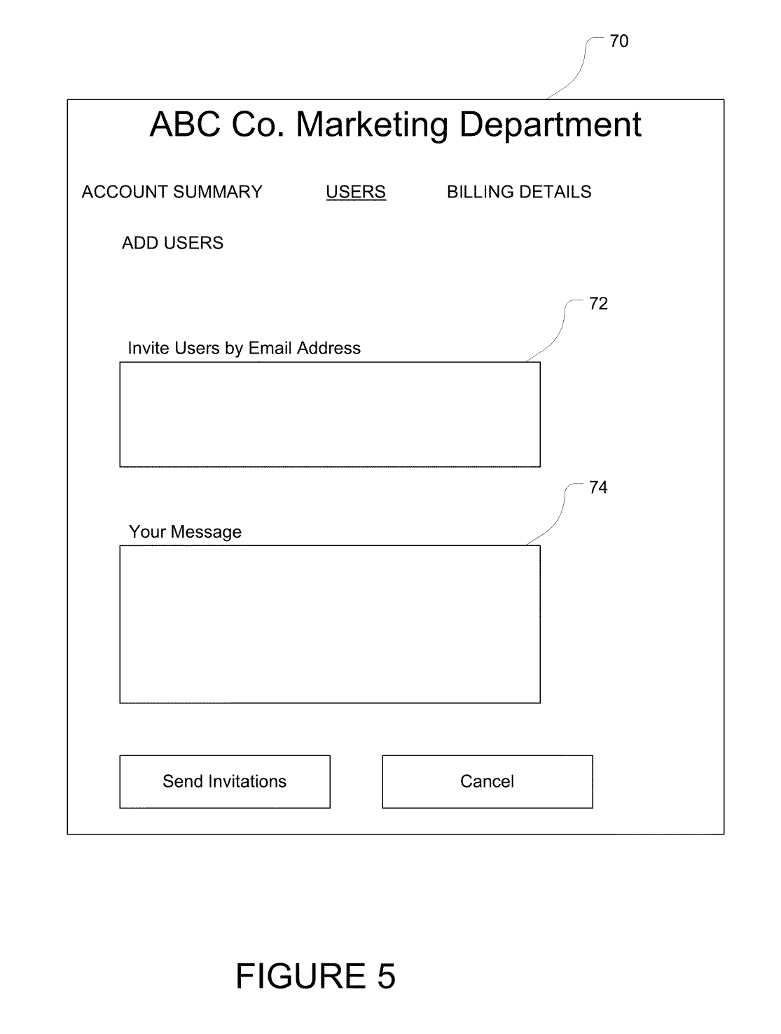

Typically, the user that sets up the account will take on the role of the administrator and owner of the account. This allows the user to generate lists of invitees, ensure that invitees have accepted their invitation, grant privileges to the various invitees, etc. FIG. 5 shows an embodiment of a user interface 70 that allows the administrator user to add users to a group, in this embodiment the marketing department of ABC Company. The interface has a first window 72 into which the administrator user can enter a list of email addresses that will cause the system to generate invitations for the people associated with those email addresses. A second window allows the user to provide a customized message 74 to the invitees explaining the invitation and the tools to which they will be granted access.

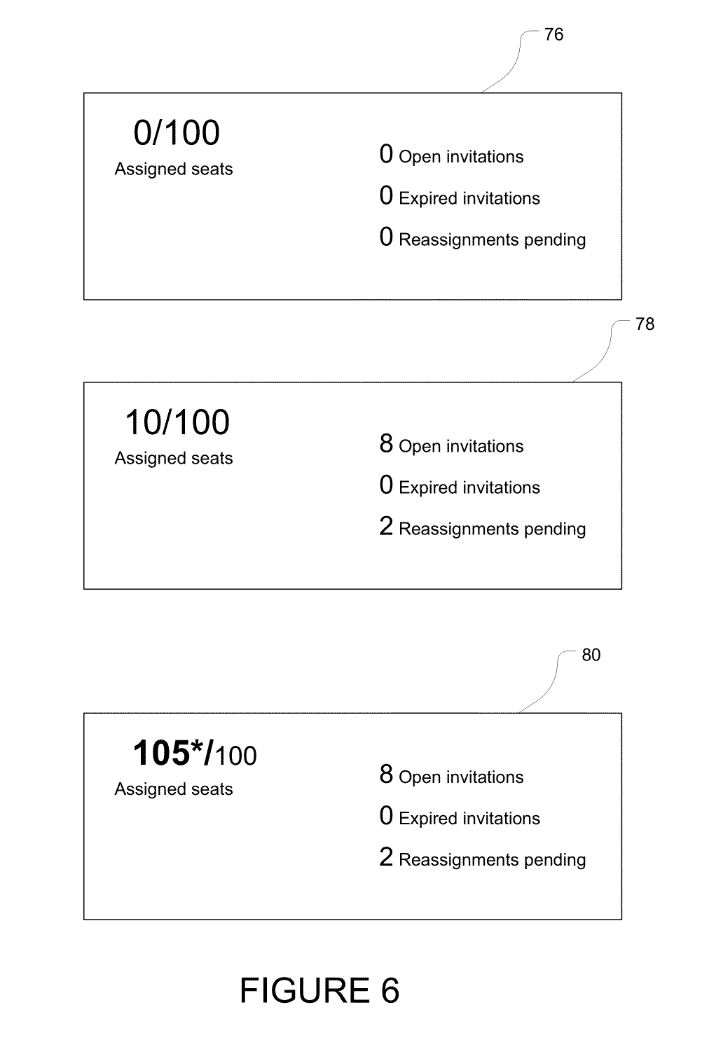

Once the invitations are sent out, the survey provider, through the invitation management module, provides the administrator user with a dashboard or status interface. This interface gives the administrator user the ability to monitor the status of the invitations and those that have been accepted, have expired or are awaiting reassignment. Examples of these status screens are shown in FIG. 6. In screen 76, the administrator user has not yet sent out any invitations. Screen 78 shows a status of 10 invitations out of the 100 originally sent out. Eight of the invitations are awaiting responses, none of expired and 2 are awaiting reassignment. Screen 80 shows an account in what is referred to as an ‘overage’ condition. An overage condition exists when more invitations are accepted than seats purchased. The screen may also notify the administrator user that the extra seats for which the enterprise will be billed separately from the original enterprise account set up.

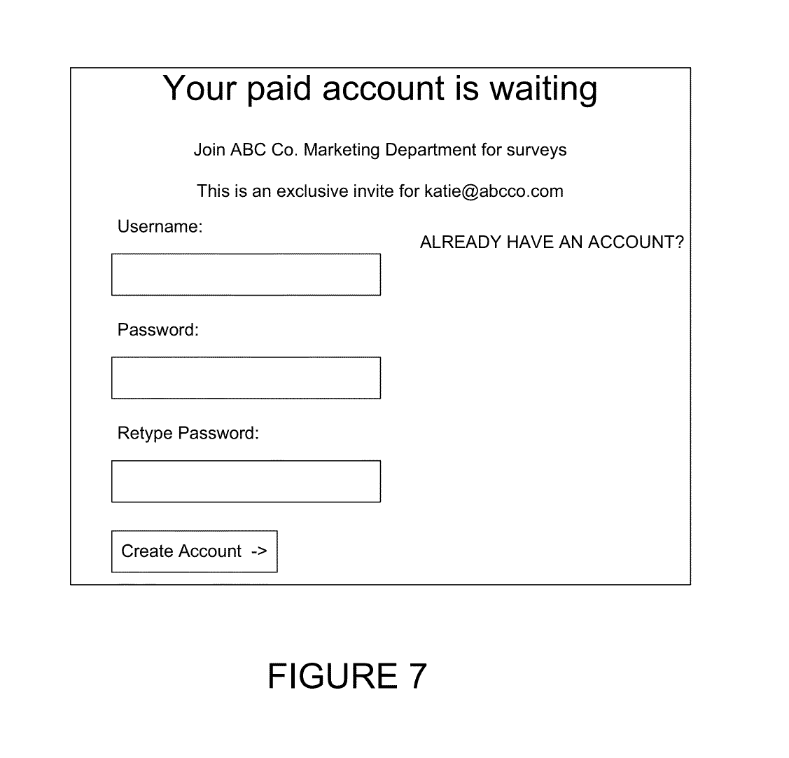

FIG. 7 shows an example of a user invitation. The invitation may pop up from an email invitation or a link from the invitation email, etc. The invitation notifies the user that the user has a paid account to which they have been invited as an entity user. The example of FIG. 7 shows that the invitation is exclusive to the user with the email address “katie@abcco.com.” The user interface allows the user to provide a username and a password and then create an account. The user interface also has a question “ALREADY HAVE AN ACCOUNT?” As will be discussed in more detail with reference to FIG. 9, users with existing accounts may join their accounts with the new enterprise account.

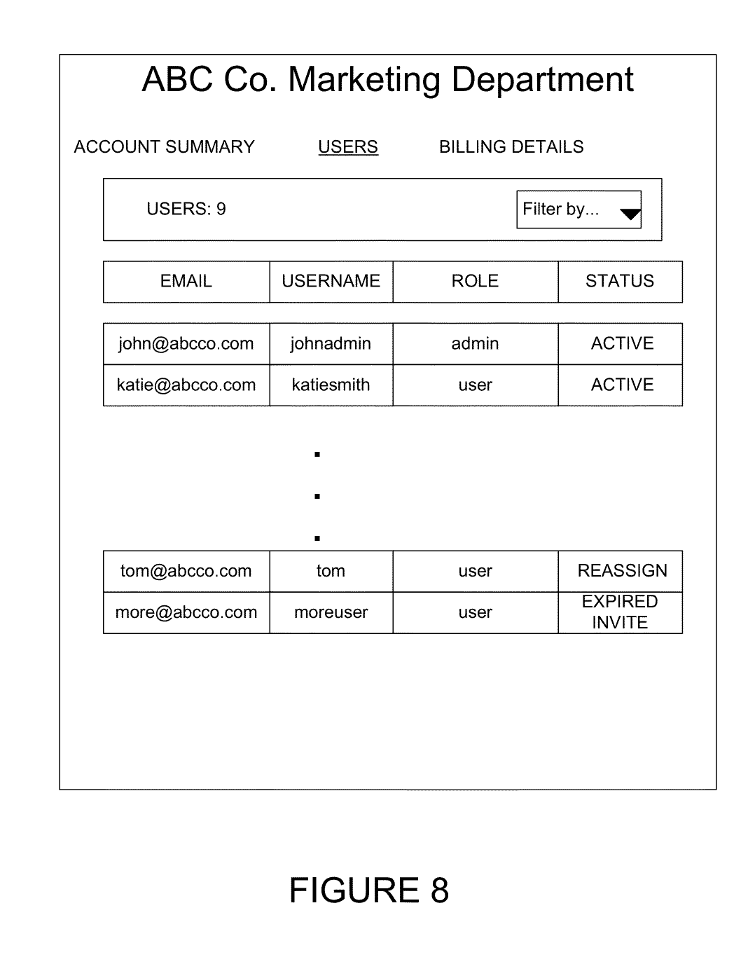

After the administrator user has sent out the invitations, the survey provider can generate a user list, an example of which is shown in FIG. 8. The user list may take on many different forms, the example of FIG. 8 is merely for discussion purposes and is not intended to limit the user list to any particular configuration. Typically, the useful information will include a number of users that are in the list, their user names, their roles and their status. One should note that while there may be only one administrator owner, other users may be designated as administrators with administrator privileges, but not necessarily the list owner. The list may be filterable by role, status, etc.

As can be seen in FIG. 8, one of the invitations is listed as ‘REASSIGN.’ Referring back to FIG. 4, users will be able to notify the survey provider that the user has an existing account. FIG. 6 also shows that 2 reassignments are pending. The reassignment designation means that the user has an existing account that is in the process of being transferred from an individual account to the enterprise account, or from one member of the group to another. FIG. 9 shows a flow chart of this process.

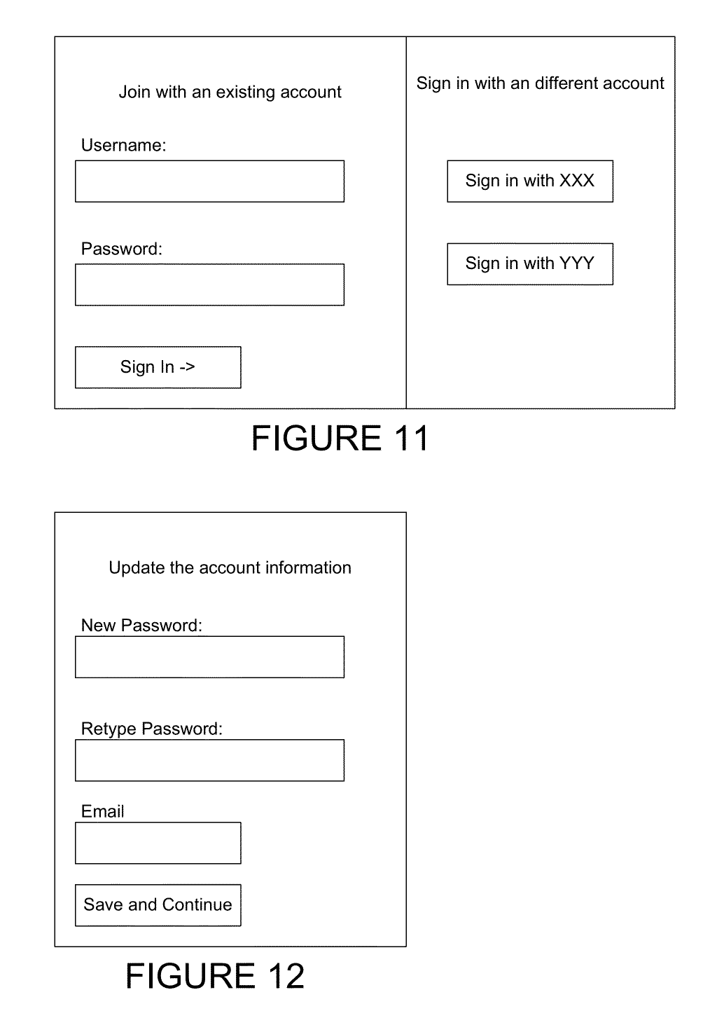

At 90, the process begins when a user has been identified as a previously existing user from the process of FIG. 4. The user is given the option to combine accounts at 90. If the user says no, the process returns to FIG. 4. If the user decides to combine accounts at 90, the survey provider generates a user interface that allows the user to identify the existing account that will be joined at 92. FIG. 11 shows an example of this interface. The user may also be able to use his or her social media accounts such as Twitter®, Facebook®, etc. to sign in. The interface may also notify the user that any information in the individual account will now become the property of the enterprise, and that the enterprise may now control the user's access to the data, the surveys, etc. Once the account is identified and joined, the user can log in and change the information to the enterprise the information at 94. An example of this type of interface is shown in FIG. 12. Referring back to FIG. 9, the survey provider will reassign the data previously associated with the individual account to the enterprise account at 96. Any data or surveys generated by the user now will belong to the enterprise.

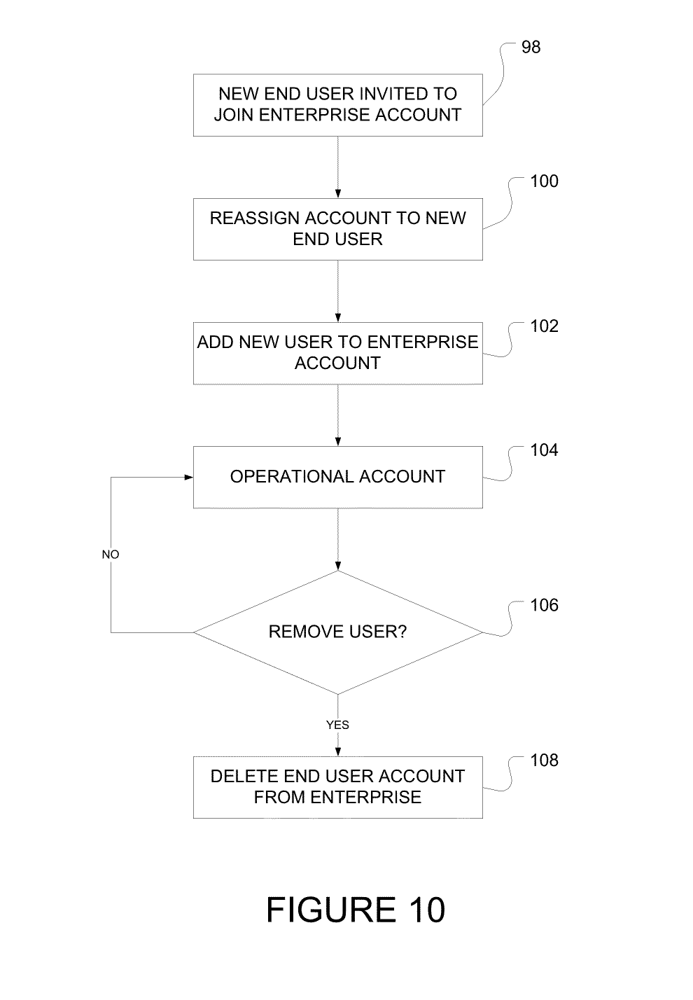

FIGS. 4 and 9 address the addition of a user at the entity level when an entity account is created. FIG. 10 addresses of adding a new user to an existing entity account. At 98 the new user is invited to join an enterprise account, a different user than was previously invited. At 100, the administrator reassigns one of the entity accounts to the new user and the user's information is added to the enterprise account at 102. Generally, this account will remain operational for however long the user remains at the entity and the entity maintains the enterprise account.

If, at some future date, the user wants to separate his or her account from the enterprise, the survey provider can accommodate that. When the request is received at 106, the system allows the user to be removed from the enterprise account by deleting the user at 108. The survey provider may also notify the user that all of the data previously associated with the user now belongs to the enterprise and the user will no longer have access to that data.

It will be appreciated that several of the above-disclosed and other features and functions, or alternatives thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. A system, comprising:
an enterprise repository configured to store at least one list of users associated with an organization and at least one list of surveys associated with the organization;
an invitation module configured to allow an inviting user associated with the organization to designate at least one invitee to become associated with the organization and to monitor acceptance by the invitee;
a management module configured to associate the invitee with the organization in the list of users upon acceptance of an invitation, the management module to monitor the list of users to ensure a number of users on the list does not exceed a predetermined number of granted licenses; and
a data repository, the data repository configured to store data received from the surveys generated by the users associated with the organization, wherein at least one user associated with the data repository has access rights to the data received through surveys.

2. The system of claim 1, further comprising a user interface configured to allow the inviting user to designate the invitees.

3. The system of claim 1, further comprising a comparison module to compare the invitees to previously registered users.

4. The system of claim 3, further comprising a consolidation module to consolidate any previously registered users and data associated with the previously registered users with the data associated with the organization.

5. The system of claim 1, wherein the data repository includes at least one database.

6. The system of claim 1, wherein the enterprise repository and the data repository reside in a same repository.

7. The system of claim 1, wherein the enterprise repository and the data repository reside are distributed.

8. The system of claim 1, wherein the invitation module and the licensing module operate on a same computer.

9. The system of claim 1, wherein the invitation module and the licensing module are distributed across a network.

10. A computer-controlled method, comprising:
receiving an input from an administrator user, the administrator user creating an account for an enterprise;
collecting information about the user and the enterprise, the information including a level of service and a number of seats for the enterprise;
receiving payment information;
creating an account for the enterprise and linking the information about the user and the enterprise and the payment information with the account as account information;
receiving a list of invitees from the administrator user;
using a mail server to send invitations to the invitees on the list; and
storing the account information and the list of invitees in a repository.

11. The computer-controlled method of claim 10, further comprising receiving a positive response from at least one of the invitees.

12. The computer-controlled method of claim 11, further comprising:
updating the account information in the repository to reflect the invitee as accepted and to update information about the invitee if necessary; and
incrementing the number of seats used for the enterprise.

13. The computer-controlled method of claim 10, further comprising receiving at least one negative response from at least one of the invitees.

14. The computer-controlled method of claim 13, further comprising:
updating the account information to reflect the invitee as declined; and
sending a message to the administrator user notifying the administrator user of the declined invitee.

15. The computer-controlled method of claim 10, further comprising monitoring the number of seats for the enterprise and a number of accepted invitations.

16. The computer-controlled method of claim 15, further comprising sending a message to the administrator user showing a difference between the number of seats for the enterprise and the number of accepted invitations.

17. The computer-controlled method of claim 15, further comprising sending a message to the administrator user notifying the administrator user of an overage condition.

18. The computer-controlled method of claim 10, further comprising checking the invitees on the list of invitees to determine if any invitee is a previously existing user.

19. The computer-controlled method of claim 18, further comprising altering the invitation for a previously existing user.

20. The computer-controlled method of claim 19, wherein altering the invitation for the previously existing user provides the previously existing user to link previous surveys to the account for the enterprise.
